(19) United States
(12) Patent Application Publication
(10) Pub. No.: US 2022/0363400 A1
(43) Pub. Date: Nov. 17, 2022

(54) AIRCRAFT FAIRING COMPRISING AT LEAST ONE FLEXIBLE JOINT CONNECTING A FIXED PANEL TO A MOVABLE PANEL

(71) Applicant: Airbus Operations SAS, Toulouse (FR)

(72) Inventors: Jean GELIOT, TOULOUSE (FR); Thierry THERON, TOULOUSE (FR)

(21) Appl. No.: 17/701,781

(22) Filed: Mar. 23, 2022

(30) Foreign Application Priority Data
Mar. 25, 2021 (FR) 2102980

(51) Int. Cl. B64D 29/06

(52) U.S. Cl. CPC B64D 29/06

(57) ABSTRACT

An aircraft fairing comprising at least one joint connecting a fixed panel to a movable panel, the joint comprising at least one first flange that is connected to the fixed panel, at least one second flange that is connected to the movable panel, and an elastically deformable junction region connecting the first and second flanges, the first and second flanges and the junction region forming a single part.

### CROSS-REFERENCES TO RELATED APPLICATIONS

This application claims the benefit of the French patent application No. 2102980 filed on Mar. 25, 2021, the entire disclosures of which are incorporated herein by way of reference.

### FIELD OF THE INVENTION

The present application relates to an aircraft fairing comprising at least one flexible joint connecting a fixed panel to a movable panel.

### BACKGROUND OF THE INVENTION

According to one embodiment, shown in FIGS. 1 and 2, an aircraft 10 comprises flanges 12, multiple engine assemblies 14 that are positioned beneath the flanges 12, and pylons 16 connecting each engine assembly to one of the flanges 12.

Each pylon 16 comprises a rigid primary structure which, among other things, serves to transmit forces between the engine assembly 14 and the flange 12, and a secondary structure which encloses the primary structure and reduces the drag of the pylon 16.

This secondary structure comprises a front fairing 18, positioned at the front of the flange 12, a central fairing, positioned below the flange 12, and a rear fairing, also termed lower rear aerodynamic fairing or APF (for “aft pylon fairing”), which is positioned to the rear of the engine assembly 14.

This front fairing 18 comprises at least one fixed panel 20 that has an opening 22, and a movable panel 24 that is configured to occupy a closed position in which the movable panel 24 blocks the opening 22 and an open position in which the movable panel 24 at least partially frees the opening 22. The front fairing 18 comprises a hinge 26 connecting a first edge 24.1 of the movable panel 24 to the fixed panel 20.

According to one embodiment, shown in FIG. 3, this hinge 26 comprises a first flange 28 connected to the fixed panel 20 by means of a bracket 30, at least one second flange 32 connected to the movable panel 24, and a pin 34 connecting the first and second flange 28, 32 so as to obtain a pivot connection. In addition to the hinge 26, the front fairing 18 comprises at least one locking system (that is distinct from the hinge) in order to keep the movable panel 24 in the closed position, this being positioned at a second edge 24.2 that is substantially parallel to and spaced apart from the first edge 24.1 of the movable panel 24. This hinge 26, made of a metallic material, is exposed to corrosion and vibrations.

### SUMMARY OF THE INVENTION

The present invention aims to propose an alternative to this hinge, by which it is possible to reduce the on-board mass.

To that end, the invention relates to an aircraft fairing comprising:

at least one fixed panel having at least one opening,

at least one movable panel that is configured to occupy a closed position in which the movable panel blocks the opening and an open position in which the movable panel at least partially frees the opening,

at least one joint connecting the fixed panel to the movable panel, the joint comprising at least one first flange that is connected to the fixed panel, at least one second flange that is connected to the movable panel, and a junction region connecting the first and second flanges, each one of the first and second flanges comprising a first edge that is connected to the junction region and a second, free edge that is remote from the junction region.

According to the invention, the junction region is designed to deform elastically, and the first and second flanges and the junction region form a single part. According to the invention, at least one of the first and second flanges comprises at least two sectors that are separated by a cut which extends from the free second edge to the first edge.

This solution makes it possible to reduce the mass of the joint, and hence the on-board mass of the aircraft.

According to another feature, the joint is designed such that, in the absence of applied loads, it adopts a stable state in which the first and second flanges enclose a first angle between them and, when subjected to a load tending to change the angle between the first and second flanges, it adopts an elastically deformed state in which the first and second flanges enclose a second angle that is different from the first angle, the joint automatically returning to the stable state when the load is removed.

According to another feature, the joint is designed to be in the stable state when the movable panel is in the closed position.

According to another feature, the fairing comprises an L-shaped bracket which has a first web that is pressed flat against and is connected to the fixed panel, and a second web, the first flange of the joint being flat against and connected to the second web of the L-shaped bracket.

According to another feature, the joint comprises at least one tab having a first end that is secured to the second flange of the joint and a second, free end, the tab being configured to adopt a holding state in which the second end cooperates with the first flange and/or the second web of the L-shaped bracket, preventing the movable panel from tipping from the closed position to the open position, and a free state in which the second end is not in contact with the first flange and/or the second web of the L-shaped bracket.

According to another feature, the first flange and the second web of the L-shaped bracket each have an edge face. In addition, the tab has a Z-shaped profile and comprises a first end segment that is pressed flat against and is connected to the second flange, an intermediate segment that is substantially parallel to the first flange, and a second end segment that is configured to cooperate with an edge face of the first flange and/or of the second web of the L-shaped bracket.

According to another feature of the invention, at least one of the first and second flanges is inserted at least partially into the fixed or movable panel.

The invention also relates to an aircraft comprising a fairing according to one of the preceding features.

### BRIEF DESCRIPTION OF THE DRAWINGS

Other features and advantages will emerge from the following description of the invention, which description is given solely by way of example, with reference to the appended drawings in which:

FIG. 1 is a perspective view of an aircraft,

FIG. 2 is a perspective view of part of a pylon of the aircraft visible in

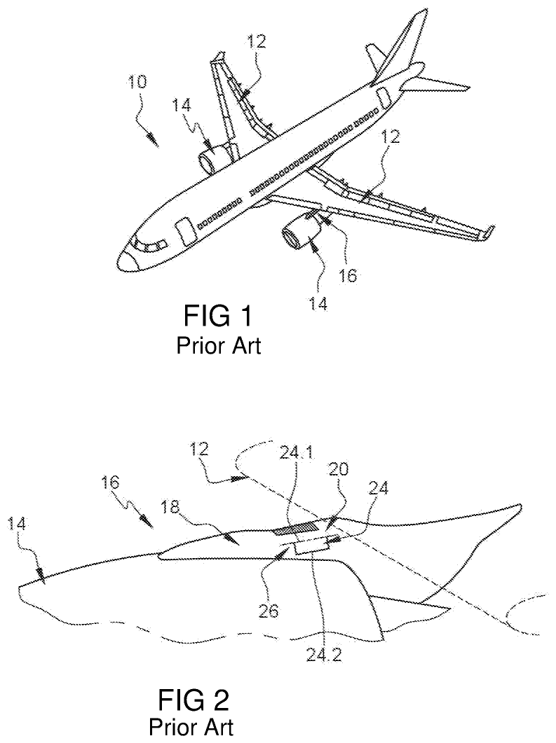

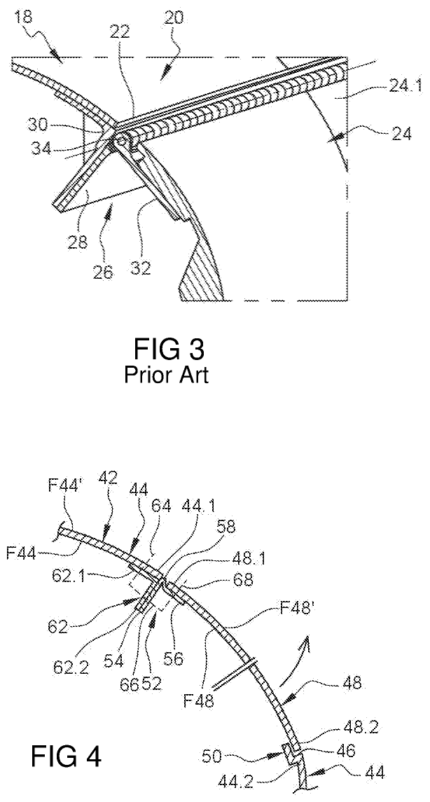

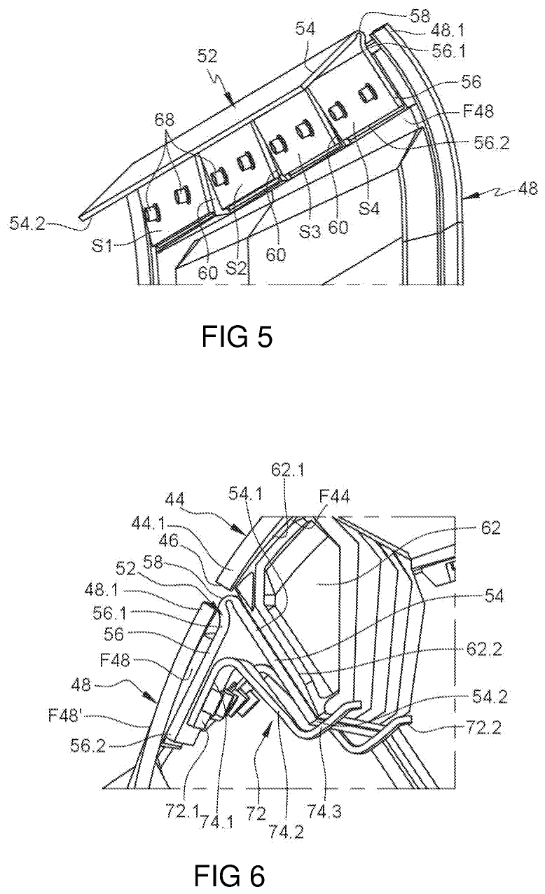

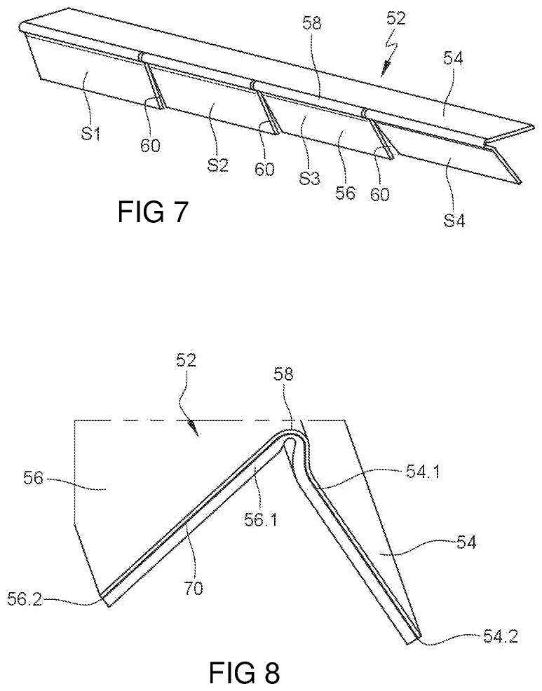

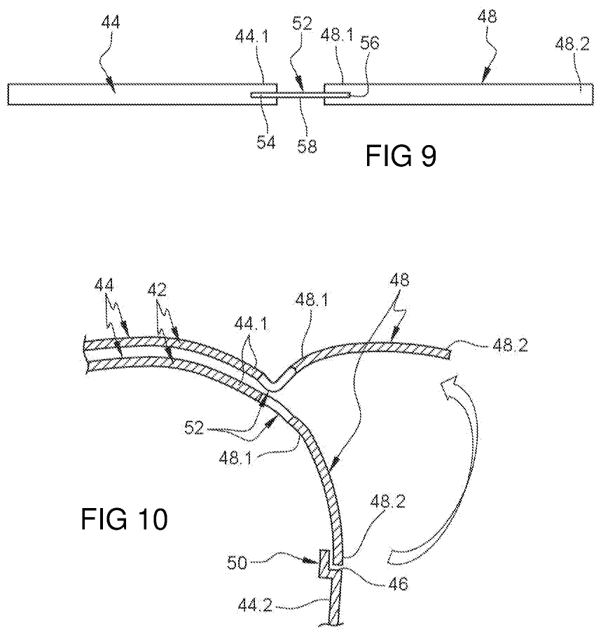

FIG. 1,

FIG. 3 is a perspective section view of a hinge connecting a movable panel to a fixed panel, illustrating one embodiment of the prior art,

FIG. 4 is a section view of a movable panel connected to a fixed panel by means of a flexible joint, illustrating one embodiment of the invention,

FIG. 5 is a perspective section view of the flexible joint visible in FIG. 4,

FIG. 6 is a perspective section view of a flexible joint connecting a fixed panel to a movable panel, illustrating another embodiment of the invention,

FIG. 7 is a perspective view of a flexible joint, illustrating an embodiment of the invention,

FIG. 8 is a section view of a flexible joint, illustrating another embodiment of the invention,

FIG. 9 is a section view of a flexible joint connecting a fixed panel to a movable panel, illustrating an embodiment of the invention, and

FIG. 10 is a schematic depiction of a movable panel in the closed and open positions, connected to a fixed panel by the flexible joint shown in FIG. 9, illustrating an embodiment of the invention.

### DETAILED DESCRIPTION OF THE PREFERRED EMBODIMENTS

In FIGS. 4 and 10, a fairing 42 of an aircraft comprises at least one fixed panel 44 that has at least one opening 46, at least one movable panel 48 that is configured to occupy a closed position in which it blocks the opening 46 and an open position in which it at least partially frees the opening 46.

The movable panel 48 has a contour that is substantially identical to the contour of the opening 46. It comprises a first edge 48.1 that is connected to the fixed panel 44, and a second edge 48.2 that is at a distance from the first edge 48.1. In addition, the fixed panel 44 comprises a first edge 44.1 which adjoins the first edge 48.1 of the movable panel 48, and a second edge 44.2 which, in the closed position, adjoins the second edge 48.2 of the movable panel 48.

According to one configuration, the contours of the movable panel 48 and of the opening 46 are approximately rectangular and, for each of these, the first and second edges 48.1, 48.2 are substantially parallel and opposite.

The fixed and movable panels 44, 48 may be curved instead of being flat. In addition, the fixed or movable panel 44 may comprise multiple juxtaposed and mutually connected portions.

According to one configuration, the second edge 44.2 of the fixed panel 44 comprises a stop 50 against which the movable panel 48 is pressed flat when in the closed position.

According to one application, the fairing 42 corresponds to part of a secondary structure of an aircraft pylon. Of course, the invention is not limited to this application, since the fairing 42 may correspond to any other portion of the fairing of an aircraft.

Each one of the fixed and movable panels 44, 48 comprises a first face F44, F48 that is oriented towards the inside of the aircraft, and a second face F44′, F48′ that is oriented towards the outside of the aircraft.

The fairing 42 comprises at least one joint 52 that connects the fixed panel 44 to the movable panel 48, and more specifically the first edges 44.1, 48.1 of the fixed and movable panels 44, 48.

This joint 52 comprises at least one first flange 54 that is connected to the fixed panel 44, at least one second flange 56 that is connected to the movable panel 48, and an elastically deformable junction region 58 connecting the first and second flanges 54, 56, the first and second flanges 54, 56 and the junction region 58 forming a single part. This solution makes it possible to reduce the mass of the joint 52, and hence the on-board mass of the aircraft.

Each one of the first and second flanges 54, 56 comprises a first edge 54.1, 56.1 that is connected to the junction region 58 and a second, free edge 54.2, 56.2 that is substantially parallel to the first edge 54.1, 56.1 and remote from the junction region 58.

According to one embodiment, shown in FIGS. 5 and 7, at least one of the first and second flanges 54, 56 comprises at least two sectors S1, S2 that are separated by a cut 60 which extends from the second edge 54.2, 56.2 to the first edge 54.1, 56.1. This solution makes it possible to adapt the shape of the first or second flange 54, 56 to the curvature of the fixed or movable panel 44, 48. According to one configuration, shown in FIGS. 5 and 7, the second flange 56 comprises four sectors S1 to S4.

According to one embodiment, shown in FIGS. 4 and 6, the first flange 54 is indirectly connected to the fixed panel 44. According to this embodiment, the fairing 42 comprises an L-shaped bracket 62 which has a first web 62.1 that is pressed flat against the first face F44 of the fixed panel 44 and is connected thereto by at least one first connection 64, and a second web 62.2 that is substantially perpendicular to the fixed panel 44 and is positioned approximately in line with the first edge 44.1 of the fixed panel 44, the first flange 54 of the joint 52 being flat against the second web 62.2 of the L-shaped bracket 62 and connected thereto by at least one second connection 66.

According to one embodiment, the first connection 64 comprises a plurality of bolts or rivets distributed along the first edge 44.1 of the fixed panel 44. As a variant, the first connection 64 could be obtained by adhesive bonding or any other similar technique. Furthermore, the first flange 54 of the joint 52 could be directly connected to the fixed panel 44, being pressed flat against its first face F44 and connected thereto.

According to one embodiment, the second connection 66 comprises a plurality of bolts or rivets distributed along the first edge 44.1 of the fixed panel 44. As a variant, the second connection 66 could be obtained by adhesive bonding or any other similar technique.

According to one embodiment, shown in FIGS. 4 and 5, the second flange 56 of the joint 52 is directly connected to the movable panel 48. Thus, the second flange 56 is pressed flat against the first face F48 of the movable panel 48 and is connected thereto by at least one third connection 68. According to one configuration, this third connection 68 comprises a plurality of bolts or rivets distributed along the first edge 48.1 of the fixed panel 48. As a variant, the third connection 68 could be obtained by adhesive bonding or any other similar technique.

According to another embodiment, at least one of the first and second flanges 54, 56 is inserted at least partially into the fixed or movable panel 44, 48. According to this embodiment, the fixed and movable panels 44, 48 are made of composite material, each starting from a preform of plies laid up from the first face F44, F48 to the second face F44′, F48′. During laying-up of the plies of fibers, the first or second flange 54, 56 is positioned between two plies of the preform of the fixed or movable panel 44, 48. After polymerization or consolidation, a strong connection is obtained between the first or second flange 54, 56 and the fixed or movable panel 44, 48. By way of example, each fixed or movable panel 44, 48 has a thickness of the order of 3 mm, and the joint 52 has a thickness of the order of 0.3 mm.

According to a first variant, the first and second flanges 54, 56 are respectively inserted into the fixed and movable panels 44, 48. According to another variant, only one of the first and second flanges 54, 56 is inserted into one of the fixed and movable panels 44, 48.

Of course, the invention is not restricted to the above-described embodiments for the connections between the joint 52 and the fixed and movable panels 44, 48.

The joint 52 is made of an elastic material. According to a first embodiment, the joint 52 is metallic, for example made of spring steel. According to a second embodiment, shown in FIG. 8, the joint 52 is made of composite material and comprises a reinforcement 70 in its thickness, for example a layer or a ply made of Kevlar.

According to one embodiment, the joint 52 is designed such that, in the absence of applied loads, it adopts a stable state in which the first and second flanges 54, 56 enclose a first angle between them and, when subjected to a load tending to change the angle between the first and second flanges 54, 56, it adopts an elastically deformed state in which the first and second flanges 54, 56 enclose a second angle that is different from the first angle, the joint 52 automatically returning to the stable state when the load is removed.

According to one configuration, the joint 52 is designed to be in the stable state when the movable panel 48 is in the closed position. When an opening force is exerted in order to tip the movable panel 48 into the open position, the joint 52 deforms elastically and passes into the elastically deformed state. In this configuration, the joint also serves to hold the movable panel 48 in the closed position.

As a variant, the joint 52 is designed to be in the stable state when the movable panel 48 is in the open position.

According to one configuration, shown in FIG. 9, in the stable state the first angle is of the order of 180° and the first and second flanges 54, 56 are approximately coplanar. According to another configuration, shown in FIGS. 5 to 7, in the stable state, the first angle formed between the first and second flanges is less than or equal to 90°.

According to one embodiment, shown in FIG. 6, the joint 52 comprises at least one system for holding the movable panel 48 in the closed position.

This holding system comprises at least one tab 72 which has a first end 72.1 that is secured to the second flange 56 of the joint 52 and a second, free end 72.2, the tab 72 being configured to adopt a holding state, corresponding to the closed position of the movable panel 48, in which the second end 72.2 cooperates with the first flange 54 and/or the second web 62.2 of the L-shaped bracket 62, and a free state, corresponding to the open position of the movable panel 48, in which the second end 72.2 is free, that is to say, the second end 72.2 is not in contact with the first flange 54 and/or the second web 62.2 of the L-shaped bracket 62. In the free state, the tab 72 allows the joint 52 to deform. In the holding state, the tab 72 prevents the joint 52 from deforming, or increases the force required to initiate the movement of the movable panel 48 tipping from the closed position to the open position.

According to one configuration, the tab 72 has a Z-shaped profile and comprises a first end segment 74.1 that is pressed flat against and is connected to the second flange 56, an intermediate segment 74.2 that is substantially parallel to the first flange 54, and a second end segment 74.3 that is configured to cooperate with the edge face of the first flange 54 and/or of the second web 62.2 of the L-shaped bracket 62. Thus, when the second end segment 74.3 cooperates with the edge face of the first flange 54 and/or of the second web 62.2 of the L-shaped bracket 62, the tab 72 prevents or hinders the tipping of the movable panel 48 from the closed position to the open position. When the second end segment 74.3 no longer cooperates with the edge face of the first flange 54 and/or of the second web 62.2 of the L-shaped bracket 62 after a slight tipping movement of the movable panel 48, then the tab 72 no longer requires an additional force in order to open the movable panel 48.

The tab 72 is configured to deform elastically when passing from the holding state to the free state, or vice versa. The tab 72 also serves to ensure that the movable panel 48 is pressed flat when in the closed position, and to prevent aerodynamic discontinuity.

Of course, the invention is not restricted to this embodiment for the system for holding the movable panel 48 in the closed position.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft fairing comprising:
at least one fixed panel having at least one opening,
at least one movable panel configured to occupy a closed position in which the movable panel blocks the opening and an open position in which the movable panel at least partially frees the opening,
at least one joint connecting the fixed panel to the movable panel, said joint comprising at least one first flange connected to the fixed panel, at least one second flange connected to the movable panel, and a junction region connecting the first flange and the second flange, the junction region being configured to deform elastically, each one of the first and second flanges comprising a first edge connected to the junction region and a second, free edge remote from the junction region, at least one of the first and second flanges comprising at least two sectors that are separated by a cut which extends from the free second edge to the first edge, the first and second flanges and the junction region forming a single part.

2. The aircraft fairing according to claim 1, wherein the joint is configured such that, in an absence of applied loads, the joint adopts a stable state in which the first and second flanges enclose a first angle between them and, when subjected to a load tending to change the angle between the first and second flanges, the joint adopts an elastically deformed state in which the first and second flanges enclose a second angle that is different from the first angle, the joint automatically returning to the stable state when the load is removed.

3. The aircraft fairing according to claim 2, in which the joint is configured to be in the stable state when the movable panel is in the closed position.

4. The aircraft fairing according to claim 1, in which the fairing comprises an L-shaped bracket which has a first web that is pressed flat against and is connected to the fixed panel, and a second web, the first flange of the joint being flat against and connected to the second web of the L-shaped bracket.

5. The aircraft fairing according to claim 4, wherein the joint comprises at least one tab having a first end secured to the second flange of the joint and a second, free end, the tab being configured to adopt a holding state in which the second end cooperates with at least one of the first flange or the second web of the L-shaped bracket, preventing the movable panel from tipping from the closed position to the open position, and a free state in which the second end is not in contact with the at least one of the first flange or the second web of the L-shaped bracket.

6. The aircraft fairing according to claim 5, wherein the first flange and the second web of the L-shaped bracket each have an edge face, and wherein the tab has a Z-shaped profile and comprises a first end segment that is pressed flat against and is connected to the second flange, an intermediate segment that is substantially parallel to the first flange, and a second end segment that is configured to cooperate with the edge face of at least one of the first flange or of the second web of the L-shaped bracket.

7. The aircraft fairing according to claim 1, wherein at least one of the first and second flanges is inserted at least partially into the fixed or movable panel.

8. An aircraft comprising a fairing according to claim 1.
